(19) United States
(12) Patent Application Publication
(10) Pub. No.: US 2023/0159855 A1
(43) Pub. Date: May 25, 2023

(54) LAUNDRY DETERGENT COMPOSITION

(71) Applicant: Conopco, Inc., d/b/a UNILEVER, Englewood Cliffs, NJ (US)

(72) Inventors: Julie BENNETT, Port Sunlight, Wirral (GB); Susanne Carina ENGERT, Bürstadt (DE); Hans-Christian RATHS, Monheim (DE); David Christopher THORLEY, Shavington (GB); Holger Michael RURK, Mannheim (DE)

(73) Assignee: Conopco, Inc., d/b/a UNILEVER, Englewood Cliffs, NJ (US)

(21) Appl. No.: 17/916,984

(22) PCT Filed: Mar. 21, 2021
(86) PCT No.: PCT/EP2021/058536

§ 371 Date: Oct. 4, 2022

(30) Foreign Application Priority Data
Apr. 9, 2020 (EP) 20169106.0

(51) Int. Cl. C11D 1/29; C11D 1/37; C11D 11/00; C11D 3/00

(52) U.S. Cl. CPC C11D 1/29; C11D 1/37; C11D 11/0017; C11D 3/0094

(57) ABSTRACT

A liquid laundry detergent composition comprising: one or more anionic and/or non-ionic surfactants; and a sulphated ethoxylated C10Guerbet alcohol surfactant with a number average degree of ethoxylation in the range of 2.5 to 6, wherein the weight ratio of total anionic and/or non-ionic surfactants to sulphated ethoxylated C10 Guerbet alcohol surfactant is from 100:1 to 30:1.

The present invention relates to improved liquid laundry detergent compositions.

This invention relates to liquid laundry detergent compositions comprising one or more anionic surfactants and a sulphated, ethoxylated C₁₀ Guerbet alcohol surfactant, and use of such compositions as a foam-enhanced detergent.

Foaming is an important aspect of the user's perception of cleaning ability in compositions such as laundry detergents whether liquid or powder, and hand dish wash compositions. There is a general consumer perception that foam volume indicates the cleaning ability of a detergent composition. Therefore, it is important to provide a sufficient foam from such a composition during use. In general, an increase in volume of foam provides a good perception with the consumer.

Laundry detergent compositions are typically added to the wash water and are required to foam in relatively dilute water conditions. The foaming ability of a composition depends on the mixture of components in the composition, and surfactants play an important role in the ability of a laundry composition to foam when in use. Typically, an increase in the amount of anionic surfactant in a composition will lead to an increase in foaming. However, an increase in anionic surfactant levels can lead to an increase in cost of the laundry detergent composition. Materials which reduce the surfactant load without compromising foaming efficiency are therefore highly desirable.

It is an aim of the present invention to provide excellent foaming from a liquid laundry detergent composition during cleaning.

In a first aspect, the present invention provides a liquid laundry detergent composition comprising:
(i) one or more anionic and/or non-ionic surfactants; and
(ii) a sulphated ethoxylated C₁₀ Guerbet alcohol surfactant with a number average degree of ethoxylation in the range of 2.5 to 6, wherein the weight ratio of total anionic and/or non-ionic surfactants to sulphated ethoxylated C10 Guerbet alcohol surfactant is from 100:1 to 30:1.

Sulphated Ethoxylated C₁₀ Guerbet Alcohol Surfactant

The liquid laundry detergent compositions of the present invention include one or more sulphated ethoxylated C₁₀ Guerbet alcohol surfactants with a number average degree of ethoxylation in the range of 2.5 to 6 as a minor surfactant component. The sulphated ethoxylated C₁₀ Guerbet surfactant or surfactants act as a foam boosting component. However, the level has to be managed carefully as we have found that the Guerbet alcohol surfactant behaves as an anti-foam if included at too high a level when compared to the remaining surfactant employed in the composition.

The preferred levels depend on the type of detergent formulation in which the sulphated Guerbet surfactant is included. For example, in laundry liquids for use in handwashing fabrics, the preferred level is from 0.01 to 2% wt. of the total composition and more preferably from 0.1 to 1.0 and most preferably from 0.2 to 0.5% wt. of the composition.

In laundry liquids for use in a top loading automatic washing machine, the preferred level is from 0.001 to 2% wt. of the total composition and more preferably from 0.01 to 1.0 and most preferably from 0.02 to 0.5% wt. of the composition.

In concentrated laundry liquids for direct use or for dilution at home, the preferred level is from 0.01 to 3% wt. of the total composition and more preferably from 0.05 to 2.0 and most preferably from 0.2 to 1.5% wt. of the composition.

Guerbet alcohols are known and well defined β-alkylated dimer alcohols. Specifically, the C10 Guerbet alcohol is also known under the IUPAC name 2-Propylheptanol. Typically, the sulphated ethoxylated C₁₀ Guerbet alcohol surfactant with a degree of ethoxylation in the range of 2.5 to 6 is exemplified by formula (I):

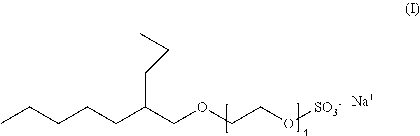

wherein 4 represents the degree of ethoxylation but can be an integer in the range of 2.5 to 6.

In some embodiments, the sulphated ethoxylated C₁₀ Guerbet alcohol surfactant has a degree of ethoxylation in the range of 2.5 to 6, 3 to 6, or 3 to 5.

Non-sulphated C₁₀ Guerbet alcohol surfactants with a degree of ethoxylation of 3, 4 or 5 are known and include Lutensol® XP-30, Lutensol® XP-40 and Lutensol® XP-50 from BASF SE, Ludwigshafen, Germany. The compositions of the invention may or may not contain any of these non-sulphated versions of the C10 Guerbet alcohol surfactants but in the context of the application the level of any non-sulphated form present is not included in any of the calculations on levels of the sulphated version.

Sulphonation of materials such as these is a simple chemical process. In preferred embodiments, the sulphated ethoxylated C₁₀ Guerbet alcohol surfactant has a degree of ethoxylation of 4 or 5. In more preferred embodiments, the C₁₀ Guerbet alcohol surfactant is a C₁₀ Guerbet alcohol surfactant with a degree of ethoxylation of 4.

The liquid laundry composition of the present invention may include two or more sulphated ethoxylated C₁₀ Guerbet alcohol surfactants with a degree of ethoxylation in the range of 2.5 to 6. In other words, the liquid laundry composition may include two or more sulphated ethoxylated C₁₀ Guerbet alcohol surfactants, each surfactant having a different degree of ethoxylation in the range of 2.5 to 6.

The total amount of the sulphated ethoxylated C₁₀ Guerbet alcohol surfactant with a degree of ethoxylation in the range of 2.5 to 6 is within the specified ranges of the present invention, namely the total amount of anionic and/or non-ionic surfactant to the sulphated ethoxylated C₁₀ Guerbet alcohol surfactant with a degree of ethoxylation in the range of 2.5 to 6 in the composition is in a weight ratio in the range of 30:1 to 100:1, more preferably from 40:1 to 60:1 (ratio is total surfactant (minus Guerbet):Guerbet surfactant).

The present inventors have surprisingly found that such a liquid laundry composition provides improved foaming ability when compared with liquid laundry detergent compositions with the same or similar total surfactant levels (save the Guerbet surfactant), in particular when compared with liquid laundry detergent compositions with the same or similar anionic surfactant levels. Further we have found that the level of guerbet alcohol surfactant is important in achieving this foam boost.

In a second aspect, the present invention provides use of a liquid laundry detergent composition according to the first aspect to launder textiles.

As used herein, the term “degree of ethoxylation” refers to the number of moles of ethylene oxide reacted with one mole of the C₁₀ Guerbet alcohol to produce the non-ionic ethoxylated C₁₀ Guerbet alcohol surfactant. It should be recognised that a distribution of ethoxylated reaction products is normally obtained during ethoxylation of, for example, alcohols. Typically, the degree of ethoxylation may therefore be designated as the “average degree of ethoxylation”, namely the average number of moles of ethylene oxide unit per mole of ethoxylated product.

Amounts of components in the liquid laundry detergent are given as a percentage of weight based on the total weight of the composition, unless otherwise stated.

It is an important aspect that the ethoxylated Guerbet alcohol surfactant is sulphated. Sulphonation is a commonly employed technique for such materials in the field and it is a routine step to sulphonate one of the known non-ionic ethoxylated Guerbet alcohol surfactants to form one of those which is used in embodiments of the invention.

The sulphated ethoxylated C₁₀ Guerbet alcohol surfactants of the present invention are typically used in their neutralized form, for example as alkali metal salts.

The compositions of the invention may or may not contain sulphated versions of the non-ethoxylated C10 Guerbet alcohol but in the context of the application the level of any sulphated but non-ethoxylated form present is not included in any of the calculations on levels of the sulphated and ethoxylated version.

Liquid Laundry Composition

It is to be understood that there is a range of compositions falling under the loose definition liquid laundry composition depending on their manner of use. These include liquids for use in front loading automatic washing machines, top loading washing machines, liquids for hand washing of fabrics, concentrated products which can be used directly or even used as a dilute at home product where a concentrate is purchased by the user and turned into a standard liquid product by the user by adding water and then stored in the usual manner. The liquid may also be a liquid unit dosed product which is contained within a water-soluble capsule.

Anionic Surfactant

The laundry liquid detergent composition preferably includes one or more anionic surfactants in an amount in the range of 2 to 30 wt %. Anionic surfactants suitable for use in liquid laundry detergents are known. In general, the anionic surfactant(s) may be chosen from the surfactants described “Surface Active Agents” Vol. 1, by 5 Schwartz & Perry, lnterscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable anionic surfactants which may be used are usually water-soluble alkali metal salts of organic carboxylates, sulphates and sulphonates having alkyl radicals containing from about 8 to about 22 carbon atoms, the term alkyl being used to include the alkyl portion of higher acyl radicals. Non-limiting examples of anionic surfactants useful herein include: C₉-C₁₈ alkyl benzene sulphonates (LAS); C₁₀-C₂₀ primary, branched-chain and random alkyl sulphates (AS); C₁₀-C₁₈ secondary (2,3) alkyl sulphates; C₁₀-C₁₈ alkyl alkoxy sulphates (AEₓS) wherein preferably x is from 1-30; C₁₀-C₁₈ alkyl alkoxy carboxylates preferably comprising 1-5 ethoxy units; mid-chain branched alkyl sulphates as discussed in U.S. Pat. Nos. 6,020,303 and 6,060,443; mid-chain branched alkyl alkoxy sulphates as discussed in U.S. Pat. Nos. 6,008,181 and 6,020,303; modified alkylbenzene sulphonate (MLAS) as discussed in WO 99/05243, WO 99/05242, and WO 99/05244; methyl ester sulphonate (MES); and alpha olefin sulfonate (AOS).

The preferred anionic surfactants are sodium C₁₁ to C₁₅ alkyl benzene sulphonates, sodium C₈ to C₁₈ alcohol ether sulphates and sodium C₁₂ to C₁₈ alkyl sulphates. Also applicable are surfactants such as those described in EP-A-0 328 177 (Unilever), which show resistance to salting-out, the alkyl polyglycoside surfactants described in EP-A-0 070 074, and alkyl monoglycosides.

In some embodiments, the composition includes a further C₈ to C₁₈ alcohol ether sulphate as an anionic surfactant. The C₈-C₁₈ alcohol ether sulphate may be derived from a fatty alcohol, wherein at least 80 wt %, preferably at least 82 wt %, more preferably at least 85 wt %, most preferably at least 90 wt % of said fatty alcohol is linear. By linear, what is meant is that the fatty alcohol comprises a single backbone of carbon atoms, with no branches.

In some embodiments, C₈ to C₁₈ alcohol ether sulphates are the only other anionic surfactants in the composition. In other embodiments, C₉ to C₁₈ alkyl benzene sulphonates are the only other anionic surfactants in the composition.

When the composition includes a C₈-C₁₈ alcohol ether sulphate, the degree of ethoxylation of the C8-C₁₈ alcohol ether sulphate is typically an integer in the range of 1 to 5. In preferred embodiments, the degree of ethoxylation of the C₈-C₁₈ alcohol ether sulphate is 1, 2 or 3.

In preferred embodiments, the composition includes sodium lauryl ether sulphate (also known as sodium dodecyl ether sulphate or SLES) as an anionic surfactant. In some embodiments, the degree of ethoxylation of SLES is 1, 2 or 3. In some embodiments, the degree of ethoxylation of SLES is 3. In other embodiments, the degree of ethoxylation of SLES is 2. In further embodiments, the degree of ethoxylation of SLES is 1.

In some embodiments, the composition includes two or more anionic surfactants. The composition may include a C₈-C₁₈ alcohol ether sulphate and one or more further anionic surfactant. The composition may include a C₉-C₁₈ alkyl benzene sulphonate and one or more further anionic surfactant. In some embodiments, the composition includes a C8-C₁₈ alcohol ether sulphate and a C₉-C₁₈ alkyl benzene sulphonate.

In some embodiments, the composition includes a C₈-C₁₈ alcohol ether sulphate or a C₉-C₁₈ alkyl benzene sulphonate in a ratio of about 1:4 to 4:1 to other anionic surfactants (when present) in the composition. In preferred embodiments the composition includes a C₈-C₁₈ alcohol ether sulphate or a C₉-C₁₈ alkyl benzene sulphonate in a ratio of about 2:3 to 7:2 to other anionic surfactants (when present) in the composition. In some embodiments the composition includes a C₈-C₁₈ alcohol ether sulphate or a C₉-C₁₈ alkyl benzene sulphonate in a ratio of about 2:3 to 3:2 to other anionic surfactants (when present) in the composition. In other embodiments, the composition includes a C₈-C₁₈ alcohol ether sulphate or a C₉-C₁₈ alkyl benzene sulphonate in a ratio of about 5:2 to 7:2 to other anionic surfactants (when present) in the composition.

In preferred embodiments, the composition includes sodium lauryl ether sulphate (SLES) and one or more further anionic surfactants. In further embodiments, the composition includes sodium lauryl ether sulphate (SLES) and sodium dodecyl benzene sulphonate (NaLAS).

The anionic surfactant or surfactants are preferably present in the composition in an amount in the range of 2 to 30 wt %.

In some more preferred embodiments, the anionic surfactant or surfactants are present in the composition in an amount in the range of 8 to 24 wt %, preferably 9 to 22 wt %.

In laundry liquids for use in handwashing fabrics, the preferred level of alkali-metal alkylether sulphate is from 2 to 25% wt. of the total composition and more preferably from 3 to 20 and most preferably from 5 to 18% wt. of the composition.

In laundry liquids for use in a top loading automatic washing machine, the preferred level of alkali-metal alkylether sulphate is from 1 to 20% wt. of the total composition and more preferably from 2 to 18 and most preferably from 2 to 13% wt. of the composition.

In concentrated laundry liquids for direct use or for dilution at home, the preferred level of alkali-metal alkylether sulphate is from 10 to 30% wt. of the total composition and more preferably from 12 to 27 and most preferably from 10 to 25% wt. of the composition.

In concentrated laundry liquids for use in a liquid unit dosed product, the preferred level of alkali-metal alkylether sulphate is from 10 to 40% wt. of the total composition and more preferably from 12 to 37 and most preferably from 10 to 30% wt. of the composition.

In some embodiments, the composition comprises 3 to 34 wt % of anionic surfactants, including from 2 to 25 wt % of C₈-C₁₈ alcohol ether sulphate (preferably SLES) and from 1 to 25 wt % of a C₉-C₁₈ alkyl benzene sulphonates (preferably sodium dodecyl benzene sulphonate).

The anionic surfactants of the present application are typically salts, for example alkali metal salts. The salts also may be organic, for example salts of triethanol amine (TEA) or monoethanol amine (MEA). However, any of the anionic surfactants of the present application may be included in the composition of the present invention in the acid form. For example, the composition may include a linear alkyl sulfonic acid as an anionic surfactant.

The weight ratio of total anionic surfactant to sulphated ethoxylated C₁₀ Guerbet alcohol surfactant with a degree of ethoxylation in the range of 2.5 to 6 in the composition is typically in the range of from 30: to 100:1 and more preferably from 40:1 to 60:1. In other words, the sulphated ethoxylated C₁₀ Guerbet alcohol surfactant with a degree of ethoxylation in the range of 2.5 to 6 is the minor surfactant component.

Other Surfactants

The composition may include other surfactants. These include additional non-ionic surfactants (other than non-sulphated,s ethoxylated C₁₀ Guerbet alcohol surfactants with a degree of ethoxylation in the range of 2.5 to 6), cationic surfactants, amphoteric surfactants and/or zwitter-ionic surfactants.

In some embodiments, the composition is substantially free of or includes up to 5 wt % of one or more zwitter-ionic surfactants. Preferred examples of zwitter-ionic surfactants are C₁₂-C₁₄ dimethyl amine oxide and cocamidopropyl betaine (CAPB). In preferred embodiments the composition is substantially free of zwitter-ionic surfactant. In other embodiments, the composition optionally includes up to 3 wt %, preferably up to 1 wt % zwitter-ionic surfactant(s).

In some embodiments, the composition includes SLES with a degree of ethoxylation of 3 and up to 3 wt % of CAPB. In some embodiments, the composition also includes a salt, such as sodium chloride, when the composition includes CAPB.

Non-Ionic Surfactants

Preferably, the composition comprises from 5 to 20% wt. non-ionic surfactant based on the total weight of composition. The composition may comprise other nonionic surfactants, for example, polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

The alcohol ethoxylate may be provided in a single raw material component or by way of a mixture of components.

Advantageously the composition comprises one or more polymers that are included in the composition, such as cleaning polymers, viscosity control polymers, structuring polymers and polymers for colour and garment care. Preferred polymers include ethoxylated polyethylene imine (available as Sokalan HP20 ex. BASF) and/or polyester soil release polymers. Preferably the detergent liquid further comprises at least 0.5 wt % ethoxylated polyethylene imine polymer. Most preferably it further comprises at least 0.2 wt % of polyester soil release polymers. More preferably the composition comprises at least 1 wt % of ethoxylated polyethylene imine.

The detergent composition may comprise an effective amount of at least one enzyme selected from the group comprising, pectate lyase, protease, amylase, cellulase, lipase, mannanase.

Enzyme Stabilisers

Any enzyme present in the composition may be stabilized using conventional stabilizing agents, e.g., a polyol for example propylene glycol or glycerol, a sugar or sugar alcohol, lactic acid, boric acid, or a boric acid derivative, e.g., an aromatic borate ester, or a phenyl boronic acid derivative for example 4-formylphenyl boronic acid, and the composition may be formulated as described in e.g. WO 92/19709 and WO 92/19708.

Fluorescers

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

Builders

A liquid composition of the invention may contain one or more builders. Builders enhance or maintain the cleaning efficiency of the surfactant, primarily by reducing water hardness. This is done either by sequestration or chelation (holding hardness minerals in solution), by precipitation (forming an insoluble substance), or by ion exchange (trading electrically charged particles).

Builders for use in liquid compositions can be of the organic or inorganic type, or a mixture thereof.

Suitable inorganic builders include hydroxides, carbonates, sesquicarbonates, bicarbonates, silicates, zeolites, and mixtures thereof. Specific examples of such materials include sodium and potassium hydroxide, sodium and potassium carbonate, sodium and potassium bicarbonate, sodium sesquicarbonate, sodium silicate and mixtures thereof.

Suitable organic builders include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Mixtures of any of the above described materials may also be used. Preferred builders for use in the invention may be selected from polycarboxylates (e.g. citrates) in acid and/or salt form and mixtures thereof.

Builder, when included, may be present in an amount ranging from about 0.1 to about 20%, preferably from about 0.5 to about 15%, more preferably from about 1 to about 10% (by weight based on the total weight of the composition).

Transition Metal Ion Chelating Agents

A liquid composition of the invention may contain one or more chelating agents for transition metal ions such as iron, copper and manganese. Such chelating agents may help to improve the stability of the composition and protect for example against transition metal catalyzed decomposition of certain ingredients.

Suitable transition metal ion chelating agents include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts. HEDP is preferred. Mixtures of any of the above described materials may also be used.

Transition metal ion chelating agents, when included, may be present in an amount ranging from about 0.1 to about 10%, preferably from about 0.1 to about 3% (by weight based on the total weight of the composition).

Fatty Acid

A liquid composition of the invention will preferably contain one or more fatty acids and/or salts thereof.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

Fatty acids and/or their salts, when included, may be present in an amount ranging from about 0.25 to 20%, more preferably from 0.5 to 15%, most preferably from 0.75 to 10% (by weight based on the total weight of the composition).

For formula accounting purposes, in the formulation, fatty acids and/or their salts (as defined above) are not included in the level of surfactant or in the level of builder.

Polymeric Cleaning Boosters

To further improve the environmental profile of liquid laundry detergents it may be preferred in some cases to reduce the volume of laundry detergent dosed per wash-load and to add various highly weight efficient ingredients to the composition to boost cleaning performance. In addition to the soil release polymers of the invention described above, a composition of the invention will preferably contain one or more additional polymeric cleaning boosters such as anti-redeposition polymers.

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 50, preferably from 15 to 40 alkoxy groups per modification. A preferred material is ethoxylated polyethyleneimine, with an average degree of ethoxylation being from 10 to 40, preferably from 15 to 35 ethoxy groups per ethoxylated nitrogen atom in the polyethyleneimine backbone.

Mixtures of any of the above described materials may also be used.

When included, a composition of the invention will preferably comprise from 0.25 to 10%, more preferably from 0.5 to 9% (by weight based on the total weight of the composition) of one or more anti-redeposition polymers such as, for example, the alkoxylated polyethyleneimines which are described above.

Soil Release Polymers

Preferably, the laundry composition comprises a soil release polymer.

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

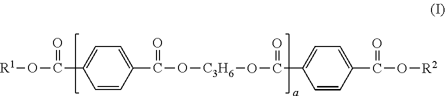

in which R¹ and R² independently of one another are X—(OC₂H₄)ₙ—(OC₃H₆)ₘ;

in which X is C₁₋₄ alkyl and preferably methyl;

n is a number from 12 to 120, preferably from 40 to 50;

m is a number from 1 to 10, preferably from 1 to 7; and

a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, preferably from 0.3 to 7%, more preferably from 0.5 to 2% (by weight based on the total weight of the composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent compositions herein in concentrations ranging from 0.01 percent to 10 percent, more preferably from 0.1 percent to 5 percent, by weight of the composition.

Polymeric Thickeners

A composition of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise from 0.1 to 5% (by weight based on the total weight of the composition) of one or more polymeric thickeners such as, for example, the HASE copolymers which are described above.

Perfume

Compositions may further comprise a perfume. The inclusion of perfumes into laundry detergent compositions is known per se.

When the composition is used at very low levels of product dosage, it is advantageous to ensure that perfume is employed efficiently.

A particularly preferred way of ensuring that perfume is employed efficiently is to use an encapsulated perfume. Use of a perfume that is encapsulated reduces the amount of perfume vapour that is produced by the composition before it is diluted. This is important when the perfume concentration is increased to allow the amount of perfume per wash to be kept at a reasonably high level.

It is even more preferable that the perfume is not only encapsulated but also that the encapsulated perfume is provided with a deposition aid to increase the efficiency of perfume deposition and retention on fabrics. The deposition aid is preferably attached to the encapsulate by means of a covalent bond, entanglement or strong adsorption, preferably by a covalent bond or entanglement.

Where perfume encapsulates are included, it is advantageous to include a structuring system in the liquid detergent to enable stable suspension of the perfume encapsulates throughout the liquid detergent

Further Optional Ingredients:

The compositions may contain one or more other ingredients. Such ingredients include preservatives (e.g. bactericides), pH buffering agents, polyelectrolytes, anti-shrinking agents, anti-wrinkle agents, anti-oxidants, sunscreens, anti-corrosion agents, drape imparting agents, anti-static agents and ironing aids. The compositions may further comprise colorants, pearlisers and/or opacifiers, and shading dye.

Dye

Dyes are described in Color Chemistry Synthesis, Properties and Applications of Organic Dyes and Pigments, (H Zollinger, Wiley VCH, Zürich, 2003) and, Industrial Dyes Chemistry, Properties Applications. (K Hunger (ed), Wiley-VCH Weinheim 2003).

The shading dye is present is present in the liquid composition in range from 0.0001 to 0.1 wt %. Depending upon the nature of the shading dye there are preferred ranges depending upon the efficacy of the shading dye which is dependent on class and particular efficacy within any particular class. As stated above the shading dye is a blue or violet shading dye.

Builders and Sequestrants

The detergent compositions may also optionally contain organic detergent builder or sequestrant material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Italmatch Chemicals and alkanehydroxy phosphonates.

Other suitable organic builders include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™.

If utilized, the organic builder materials may comprise from about 0.5% to 20 wt%, preferably from 1 wt % to 10 wt %, of the composition. The preferred builder level is less than 10 wt % and preferably less than 5 wt % of the composition. A preferred sequestrant is HEDP (1-Hydroxyethylidene-1,1,-diphosphonic acid), for example sold as Dequest 2010. Also suitable but less preferred as it gives inferior cleaning results is Dequest® 2066 (Diethylenetriamine penta(methylene phosphonic acid or Heptasodium DTPMP).

Buffers

The presence of some buffer is preferred for pH control; preferred buffers are MEA, and TEA. If present they are preferably used in the composition at levels of from 1 to 15 wt %.

External Structurants

The compositions may have their rheology modified by use of a material or materials that form a structuring network within the composition. Suitable structurants include hydrogenated castor oil, structuring polymers, microfibrous cellulose and natural based structurants for example citrus pulp fibre. Citrus pulp fibre is particularly preferred especially if lipase enzyme is included in the composition.

Packaging and Dosing

The laundry liquid composition of the invention may be packaged as unit doses in polymeric film soluble in the wash water. Alternatively, a composition of the invention may be supplied in multi-dose plastics packs with a top or bottom closure. A dosing measure may be supplied with the pack either as a part of the cap or as an integrated system.

A method of laundering fabric using a composition of the invention will usually involve diluting the dose of detergent composition with water to obtain a wash liquor, and washing fabrics with the wash liquor so formed.

The dilution step preferably provides a wash liquor which comprises inter alia from about 3 to about 20 g/wash of detersive surfactants (as are further defined above).

In automatic washing machines the dose of detergent composition is typically put into a dispenser and from there it is flushed into the machine by the water flowing into the machine, thereby forming the wash liquor. From 5 up to about 65 litres of water may be used to form the wash liquor depending on the machine configuration. The dose of detergent composition may be adjusted accordingly to give appropriate wash liquor concentrations. For example, dosages for a typical front-loading washing machine (using 10 to 15 litres of water to form the wash liquor) may range from about 10 ml to about 60 ml, preferably about 15 to 40 ml. Dosages for a typical top-loading washing machine (using from 40 to 60 litres of water to form the wash liquor) may be higher, e.g. up to about 100 ml.

A subsequent aqueous rinse step and drying the laundry is preferred.

### EXAMPLE 1

A test detergent including around 20 wt % of an anionic surfactant and around 1 wt % of a non-ionic ethoxylated C₁₀ Guerbet alcohol surfactant with a degree of ethoxylation of 4 (XP40) was compared in foaming tests against a test detergent including around 20 wt % of an anionic surfactant and around 1 wt % of a sulphated ethoxylated C₁₀ Guerbet alcohol surfactant with a degree of ethoxylation of 4 (sulphated XP40).

Foaming tests were performed by adding a fixed amount of detergent composition in a fixed volume of water and inverting the mixtures in a graduated vessel. The tests were performed three times and an average foam volume taken.

TABLE 1

| | XP40 | Sulphated XP40 |
|---|---|---|
| Laundry Liquid (TLA) | No effect | Large Benefit |
| Laundry Powder (HW) | No effect | Large Benefit |
| Hand Dishwash | Small Benefit | Large Benefit |

Baseline level of surfactant was 1000 ppm. This was replaced by 1/50 XP40 in the controls and Sulphated XP40 in the test samples.

The data does not only show that sulphate XP40 performs better as a foam booster in hand dish wash compositions but it provides a benefit in powder hand wash (fabric) and liquid top loader automatic (fabric) where no effect is seen at all with the non-sulphated equivalent.

### EXAMPLE 2

In the second example test samples were designed to illustrate the effect of different levels of the Guerbet alcohol surfactant with respect to the remaining anionic surfactant.

TABLE 2

| Ratio | Foam | | | |
|---|---|---|---|---|
| Surfactant | Height | Std | Lower | Upper |
| base:SXP40 | (cm) | Error | 95% | 95% |
| 100:0 | 8.5 | 0.21651 | 7.8989 | 9.101 |
| 200:1 | 7.75 | 0.21651 | 7.1489 | 8.351 |
| 100:1 | 9 | 0.30619 | 8.1499 | 9.85 |
| 60:1 | 10 | 0.30619 | 9.1499 | 10.85 |
| 50:1 | 10.25 | 0.21651 | 9.6489 | 10.851 |
| 40:1 | 10.25 | 0.30619 | 9.3999 | 11.1 |
| 20:1 | 8 | 0.30619 | 7.1499 | 8.85 |
| 10:1 | 7.75 | 0.21651 | 7.1489 | 8.351 |

The data shows that very low levels and relatively high levels of the Guerbet alcohol surfactant actually inhibit foaming.

Protocol:

Surfactant concentration—0.2 gpl

Water hardness—12° FH (2:1 Ca:Mg)

Temperature—22° C.

pH—7

Base Surfactant system—3:1 SLES 3EO:LAS

Total surfactant concentration (including Guerbet alcohol surfactant) was 0.2 gpl
2 litres of wash liquor was added to the bucket and this was agitated by hand.
Hand is horizontal to the bottom of the bucket and fingers spread out. The hand is then moved in a sideways action just breaking the surface of the solution for 20 seconds.

The foam is then left to drain for 30 seconds after which a ruler is placed in the bucket and the height of the top of the foam measured from the bottom of the bucket is recorded.

Experiment is repeated.

Data is then analysed (Annova and Tukey Kramer test) and tabulated.

1. A liquid laundry detergent composition comprising:
(i) one or more anionic and/or non-ionic surfactants; and
(ii) a sulphated ethoxylated C₁₀ Guerbet alcohol surfactant with a number average degree of ethoxylation in the range of 2.5 to 6, wherein the weight ratio of total anionic and/or non-ionic surfactants to sulphated ethoxylated C10 Guerbet alcohol surfactant is from 100:1 to 30:1.

2. A liquid laundry detergent composition according to claim 1 wherein the total amount of anionic and/or non-ionic surfactant in the composition, excluding the sulphated ethoxylated C₁₀ Guerbet alcohol surfactant, is in the range of 2 to 30 wt % of the total composition.

3. A liquid laundry detergent composition according to claim 1, wherein the sulphated ethoxylated C₁₀ Guerbet alcohol surfactant is selected from the group consisting of sulphated ethoxylated C₁₀ Guerbet alcohol surfactants with a degree of ethoxylation of 3, 4 or 5.

4. A liquid laundry detergent composition according to claim 1 wherein the sulphated ethoxylated C₁₀ Guerbet alcohol surfactant is a mixture of different sulphated ethoxylated C₁₀ Guerbet alcohol surfactants selected from the group consisting of C₁₀ Guerbet alcohol surfactants with a degree of ethoxylation of 3, 4 and 5.

5. A liquid laundry detergent composition according to claim 1 wherein the sulphated ethoxylated C₁₀ Guerbet alcohol surfactant has a degree of ethoxylation of 4 or 5.

6. A liquid laundry detergent composition according to claim 1 wherein the composition includes 0.02 to 3.0 wt % of the sulphated ethoxylated C₁₀ Guerbet alcohol surfactant with a degree of ethoxylation in the range of 1 to 10 based on the total weight of the composition.

7. A liquid laundry detergent composition according to claim 1 wherein the composition includes 0.02 to 3.0 wt % of the sulphated ethoxylated C₁₀ Guerbet alcohol surfactant with a degree of ethoxylation in the range of 2.5 to 6 based on the total weight of the composition.

8. A liquid laundry detergent composition according to claim 1 wherein the composition includes 18 to 24 wt % of sodium lauryl ether sulphate (SLES) and/or sodium dodecyl benzene sulphonate (NaLAS).

9. A liquid laundry detergent composition according to claim 1 wherein the weight ratio of the total amount of surfactant (excluding the Guerbet surfactant) to the sulphated ethoxylated C₁₀ Guerbet alcohol surfactant is in the range of 40:1 to 60:1.

10. A liquid laundry detergent composition according to claim 1 wherein the composition further includes one or more additional components selected from the group consisting of: ethoxylated polyethylene imine polymer; polyester soil release polymer; one or more enzymes; enzyme stabiliser; fluorescent agent; bleach catalyst; and perfume.
